(19) United States
(12) Patent Application Publication
(10) Pub. No.: US 2025/0023673 A1
(43) Pub. Date: Jan. 16, 2025

(54) COMMUNICATION IN SIDELINK POSITIONING

(71) Applicant: Nokia Technologies Oy, Espoo (FI)

(72) Inventors: Yong LIU, Shanghai (CN); Mikko SÄILY, Laukkoski (FI); Tao TAO, Shanghai (CN); Dong LI, Shanghai (CN); Ryan KEATING, Chicago, IL (US)

(21) Appl. No.: 18/714,388

(22) PCT Filed: Dec. 6, 2021
(86) PCT No.: PCT/CN2021/135755

§ 371 Date: May 29, 2024

(51) Int. Cl. H04L 5/00

(52) U.S. Cl. CPC H04L 5/0005; H04L 5/0037; H04L 5/0051

(57) ABSTRACT

Embodiments of the present disclosure relate to communication in sidelink positioning. According to one aspect of the present disclosure, a second device generates a second PRS for positioning of a first device by using a set of second devices including the second device and transmits the second PRS to the first device. The first device communicates with the set of second devices via a sidelink interface. The second PRS is at least transmitted over a bandwidth occupied by a second set of sidelink data channels from the set of second devices to the first device in a time slot. In this way, an improved transmission of PRS from a supporting device is achieved, and efficient and low latency sidelink based ranging/positioning is allowed.

### FIELD

Embodiments of the present disclosure generally relate to the field of telecommunication and in particular, to a method, device, apparatus and computer readable storage medium for communication in sidelink positioning.

### BACKGROUND

As a result of native positioning support in new radio (NR), some positioning solutions are specified for NR, such as downlink time difference of arrival (DL-TDOA), uplink time difference of arrival (UL-TDOA), downlink angle of departure (DL-AoD), uplink angle of arrival (UL-AoA) and multi-cell round trip time (Multi-RTT).

Currently, different positioning technologies are studied to meet accuracy requirements in vehicle-to-everything (V2X) applications, and sidelink positioning is identified as important to meet high accuracy use cases, especially when global navigation satellite system (GNSS) coverage is unavailable. Recently, standardization of sidelink positioning is being continuously pushed. However, a solution of sidelink positioning is still incomplete and is to be further developed.

### SUMMARY

In general, example embodiments of the present disclosure provide a solution for communication in sidelink positioning.

In a first aspect, there is provided a first device. The first device comprises at least one processor; and at least one memory including computer program code; the at least one memory and the computer program code are configured to, with the at least one processor, cause the first device to: generate a first positioning reference signal for positioning of the first device by using a set of second devices, wherein the first device communicates with the set of second devices via a sidelink interface; and transmit the first positioning reference signal to the set of second devices, the first positioning reference signal at least being transmitted over a bandwidth occupied by a first set of sidelink data channels from the first device to the set of second devices in a first time slot.

In a second aspect, there is provided a second device. The second device comprises at least one processor; and at least one memory including computer program code; the at least one memory and the computer program code are configured to, with the at least one processor, cause the second device to: generate a second positioning reference signal for positioning of a first device by using a set of second devices comprising the second device, wherein the first device communicates with the set of second devices via a sidelink interface; and transmit the second positioning reference signal to the first device, the second positioning reference signal at least being transmitted over a bandwidth occupied by a second set of sidelink data channels from the set of second devices to the first device in a second time slot.

In a third aspect, there is provided a method for communication. The method comprises: generating, at a first device, a first positioning reference signal for positioning of the first device by using a set of second devices, wherein the first device communicates with the set of second devices via a sidelink interface; and transmitting the first positioning reference signal to the set of second devices, the first positioning reference signal at least being transmitted over a bandwidth occupied by a first set of sidelink data channels from the first device to the set of second devices in a first time slot.

In a fourth aspect, there is provided a method for communication. The method comprises: generating, at a second device, a second positioning reference signal for positioning of a first device by using a set of second devices comprising the second device, wherein the first device communicates with the set of second devices via a sidelink interface; and transmitting the second positioning reference signal to the first device, the second positioning reference signal at least being transmitted over a bandwidth occupied by a second set of sidelink data channels from the set of second devices to the first device in a second time slot.

In a fifth aspect, there is provided an apparatus for communication. The apparatus comprises: means for generating, at a first device, a first positioning reference signal for positioning of the first device by using a set of second devices, wherein the first device communicates with the set of second devices via a sidelink interface; and means for transmitting the first positioning reference signal to the set of second devices, the first positioning reference signal at least being transmitted over a bandwidth occupied by a first set of sidelink data channels from the first device to the set of second devices in a first time slot.

In a sixth aspect, there is provided an apparatus for communication. The apparatus comprises: means for generating, at a second device, a second positioning reference signal for positioning of a first device by using a set of second devices comprising the second device, wherein the first device communicates with the set of second devices via a sidelink interface; and means for transmitting the second positioning reference signal to the first device, the second positioning reference signal at least being transmitted over a bandwidth occupied by a second set of sidelink data channels from the set of second devices to the first device in a second time slot.

In a seventh aspect, there is provided a non-transitory computer readable medium comprising program instructions for causing an apparatus to perform the method according to the third aspect.

In an eighth aspect, there is provided a non-transitory computer readable medium comprising program instructions for causing an apparatus to perform the method according to the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which embodiments of the present disclosure may be implemented;

FIG. 2A illustrates a flowchart illustrating a process of communication in sidelink positioning according to some embodiments of the present disclosure;

FIG. 2B illustrates a diagram illustrating an example transmission of a positioning reference signal (PRS) from a target device according to some embodiments of the present disclosure;

FIG. 2C illustrates a diagram illustrating another example transmission of a PRS from a target device according to some embodiments of the present disclosure;

FIG. 3A illustrates a flowchart illustrating another process of communication in sidelink positioning according to some embodiments of the present disclosure;

FIG. 3B illustrates a diagram illustrating an example transmission of a set of PRSs from a set of support devices according to some embodiments of the present disclosure;

FIG. 3C illustrates a diagram illustrating another example transmission of a set of PRSs from a set of support devices according to some embodiments of the present disclosure;

FIG. 4A illustrates a flowchart illustrating still another process of communication in sidelink positioning according to some embodiments of the present disclosure;

FIG. 4B illustrates a diagram illustrating an example positioning for a target device by using a set of support devices according to some embodiments of the present disclosure;

FIG. 5 illustrates a flowchart of an example method implemented at a first device as a target device according to some embodiments of the present disclosure;

FIG. 6 illustrates a flowchart of an example method implemented at a second device as a support device according to some embodiments of the present disclosure;

FIG. 7 illustrates a simplified block diagram of a device that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR next generation NodeB (also referred to as a gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting RRC, SDAP and PDCP) controlling a plurality of gNB-DUs (Distributed unit, hosting RLC, MAC and PHY).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

In the third generation partnership project (3GPP) Release 17, there is a further work on NR positioning with the main target being the Industrial IoT use cases. In 3GPP Release 16, support for V2X was also added to NR in the form of sidelink communications. Enhancements to the sidelink are also being made in Release 17. As of yet ranging and positioning support have not been added to the sidelink and the positioning work has kept sidelink explicitly out of the scope of the work. However, many sidelink use cases have ranging and positioning requirements (e.g., self-driving vehicles and public safety).

The 5G automotive association (5GAA) has studied different positioning technologies that may be used to meet the accuracy requirements in V2X applications. Sidelink positioning has been identified as important to meet high accuracy use cases, especially when GNSS coverage is not available.

In the V2X standardization process in previous 3GPP releases, standardization of sidelink ranging and positioning is being continuously pushed. Even sidelink ranging alone is of substantial value to V2X applications (e.g. collision avoidance/warning based on distance).

Radio access network (RAN) plenary has completed a study item in 3GPP Release 17 to identify the use cases and requirements of V2X and sidelink positioning. Recent 3GPP Release 18 Workshop and RAN plenary meeting has considered methods for evolving NR positioning and sidelink positioning/ranging is among the strongest candidates for 3GPP Release 18 study items and further normative work.

It was observed that positioning requirements and service levels in V2X depend on a service that a device (for example, UE) operates and are applicable to relative and absolute positioning. In general, accuracy of 2 to 3 m is needed for absolute positioning. However, in V2X, the relative positioning using ranging is required to be 0.2 m (relative vertical accuracy) with 95 to 99.9% positioning service availability at 10 ms to 1 s positioning service latency. The device velocity up to 250 km/h needs to be supported for outdoor and tunnel areas. Thus, tight requirements require good coordination between vehicles attending a sidelink positioning session.

To achieve the above ranging/positioning requirements, coordinated information of measurements based on a received PRS may be exchanged between relevant devices. A target device or a supporting device may need to transmit a PRS and also physical sidelink control channel (PSCCH)/physical sidelink shared channel (PSSCH) containing resource allocation or measurement related information to its corresponding device(s).

Embodiments of the present disclosure provide a solution of sidelink PRS transmission. In the solution, for a positioning of a target device by using a set of supporting devices, a PRS is transmitted in a manner such that the PRS is transmitted over the whole bandwidth occupied by a set of sidelink data channels (e.g., PSSCH) associated with the set of supporting devices in the same time slot. In this way, fast ranging/positioning meeting accuracy requirements may be effectively realized.

Principles and implementations of the present disclosure will be described in detail below with reference to the figures.

### Example of Communication Environment

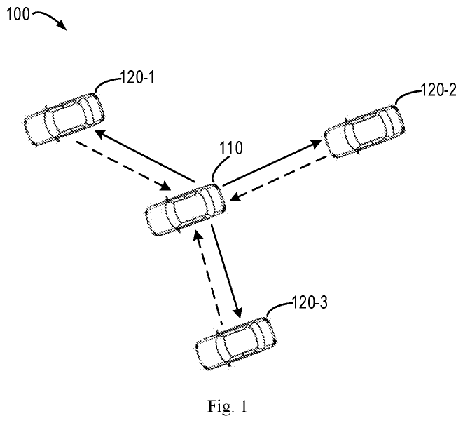

FIG. 1 illustrates a schematic diagram of an example communication environment 100 in which embodiments of the present disclosure can be implemented. As shown in FIG. 1, the communication environment 100 may involve a first device 110 and second devices 120-1, 120-2 and 120-3. For convenience, the second devices 120-1, 120-2 and 120-3 may be collectively referred to as second devices 120 hereinafter.

In this example, the first device 110 and the second devices 120 are illustrated as vehicles. It should be noted that the first device 110 and the second devices 120 may be any other suitable types of terminal devices or network devices, such as mobile phones, sensors and so on. Further, it is to be understood that the number of first and second devices is only for the purpose of illustration without suggesting any limitations. The communication environment 100 may include any suitable number or type of first and second devices adapted for implementing embodiments of the present disclosure.

In addition, the communication environment 100 may further include one or more devices (not shown) serving the first device 110 and/or second device 120. For example, the one or more devices may communicate with the first device 110 and/or second device 120 via an air interface such as Uu interface or the like.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The first device 110 and the second devices 120 may communicate with each other via a sidelink interface. For example, the first device 110 and the second devices 120 may communicate with each other via a sidelink data channel such as a PSSCH, a sidelink control channel such as a PSCCH or a sidelink feedback channel (PSFCH), or any other existing or future sidelink channels.

In some scenarios, the first device 110 may be positioned by using the second devices 120. This may be called as a sidelink ranging or positioning. In these scenarios, the first device 110 may also be called as a target device, and the second devices 120 may also be called as supporting devices or anchor devices.

Sidelink ranging between a pair of devices (i.e., a target device and a supporting device) is foundation of sidelink positioning. For sidelink ranging, round trip time (RTT) may be a suitable method since terminal devices are usually not synchronized as well as network devices. In the example of FIG. 1, the first device 110 may transmit a PRS to the second devices 120 (as shown by a solid arrow), and then later receive another PRSs from the second devices 120 (as shown by a dotted arrow). In this way, the RTT may be evaluated.

It is to be understood that RTT is merely an example, and the first device 110 may be positioned based on PRS transmission in any other suitable positioning solutions such as DL-TDOA, UL-TDOA, DL-AOD, UL-AoA or the like.

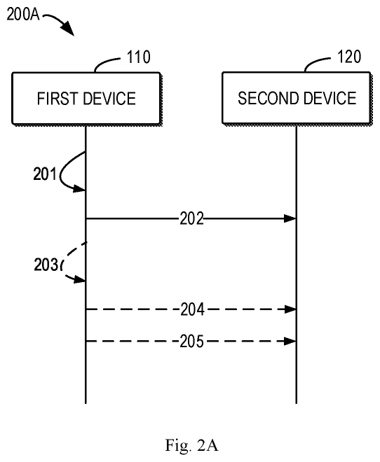

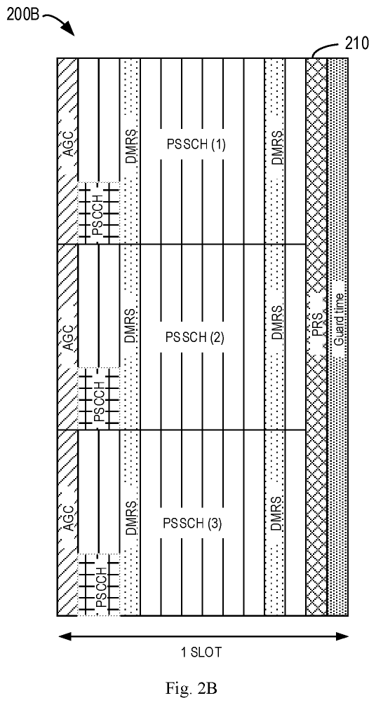

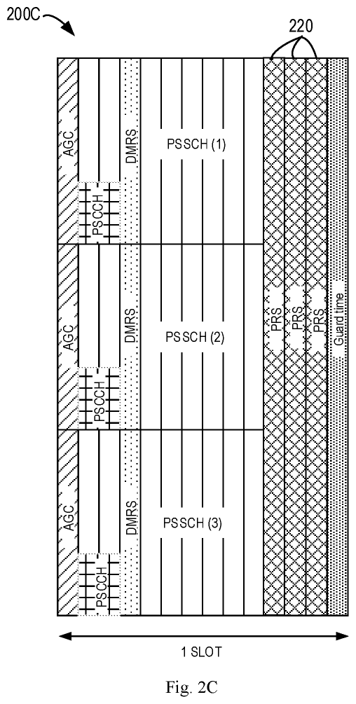

Embodiments of the present disclosure provide a solution of coordinated PRS transmission in sidelink positioning. In the solution, a PRS is transmitted in a manner such that the PRS is transmitted over the whole bandwidth occupied by a set of sidelink data channels associated with a set of supporting devices in the same time slot. In this way, transmission latency is reduced to better realize fast positioning and ranging/positioning performance is improved by exploiting wider bandwidth for PRS transmissions. More details will be described below in connection with FIGS. 2 to 5.

Example Implementation of PRS Transmission from Target Device

In this embodiment, a solution of PRS transmission from a target device (e.g., the first device 110) is described with reference to FIGS. 2A, 2B and 2C.

FIG. 2A illustrates a flowchart illustrating a process 200A of communication in sidelink positioning according to some embodiments of the present disclosure. For the purpose of discussion, the process 200A will be described with reference to FIG. 1. The process 200A may involve the first and second devices 110 and 120 as illustrated in FIG. 1. It would be appreciated that although the process 200A has been described in the communication environment 100 of FIG. 1, this process may be likewise applied to other communication scenarios. Assuming that the first device 110 is to be positioned by using a set of the second devices 120 (i.e., the second devices 120-1, 120-2 and 120-3). The number of second devices in the set of second devices 120 may be greater than or equal to 2. That is, the first device 110 is a target device, and the set of second devices are a set of supporting devices.

As shown in FIG. 2A, the first device 110 generates 201 a PRS (for convenience, also referred to as a first PRS herein). The PRS may be designed in any suitable forms, and the present disclosure does not limit this aspect.

Then the first device 110 transmits 202 the first PRS to the set of second devices 120. According to embodiments of the present disclosure, the first PRS is at least transmitted over a bandwidth occupied by a set of sidelink data channels (for convenience, also referred to as a first set of sidelink data channels herein) associated with the set of second devices 120 in a time slot (for convenience, also referred to as a first time slot herein). The first set of sidelink data channels are transmitted from the first device 110 to the set of second devices 120. Thereby, by exploiting wider bandwidth for PRS transmissions from a target device, transmission latency may be reduced to better realize fast positioning and ranging/positioning performance may be improved.

In some embodiments, the first PRS may be transmitted over the whole bandwidth occupied by the first set of sidelink data channels towards the set of supporting devices. In some embodiments, in addition to the bandwidth occupied by the first set of sidelink data channels towards the set of supporting devices, the first PRS may also be transmitted over a bandwidth occupied by one or more other sidelink data channels towards one or more devices other than the set of supporting devices.

In some embodiments, sidelink data channels in the first set of sidelink data channels may be transmitted in the same time slot (i.e., in the first time slot). In some embodiments, the sidelink data channels in the first set of sidelink data channels may be distributed continuously in frequency domain. In this way, transmission performance of PRS from a target device may be enhanced and accuracy of sidelink positioning may be improved. Of course, the sidelink data channels in the first set of sidelink data channels may be not distributed continuously in frequency domain. The present disclosure does not limit this aspect.

In some embodiments, the first device 110 may generate 203 information (for convenience, also referred to as first information herein) of a resource to be used for transmission of another PRS (for convenience, also referred to as a second PRS herein) in another time slot (for convenience, also referred to as a second time slot herein). The second PRS is to be transmitted from a second device (for example, the second device 120-1) in the set of second devices 120 to the first device 110. In some embodiments, the second time slot may be later in time domain than the first time slot. Of course, the second time slot may be earlier in time domain than the first time slot, or the second time slot and the first time slot may be the same time slot. In some embodiments, the first device 110 may coordinate the resources for the set of second devices 120 so that second PRSs from the set of second devices 120 are at least transmitted over the whole bandwidth occupied by a set of sidelink data channels associated with the set of second devices 120 in the same time slot (i.e., in the second time slot).

The first device 110 may transmit 204 the information indicative of the resource to the second device 120-1. In some embodiments, the first device 110 may transmit the first information with the first PRS in the first time slot. For example, the first device 110 may transmit a PSCCH/PSSCH conveying the first information and associated PRS in the same time slot.

In some embodiments, the first device 110 may transmit 205, to the set of second devices 120, information (for convenience, also referred to as third information herein) indicative of transmission power applied by the first device 110. For example, the first device 110 may include the information indicative of transmission power in a PSCCH/PSSCH transmitted to a respective device in the set of second devices 120. This facilitates determination of path loss at a supporting device, and may reduce inter-carrier interference (ICI) for PRS reception from the supporting device at a target device to combat near far effect.

In some embodiments, the first PRS may be transmitted via one symbol. In some embodiments, the first PRS may be transmitted via multiple symbols. For illustration, some examples for PRS transmission from a target device will be described with reference to FIGS. 2B and 2C. FIG. 2B illustrates a diagram 200B illustrating an example transmission of a PRS from a target device according to some embodiments of the present disclosure. For the purpose of discussion, this will be described with reference to FIG. 1. Assuming that the first device 110 is a target device, and the second devices 120 are supporting devices.

In the example of FIG. 2B, the first device 110 transmits multiple PSSCHs (i.e., PSSCH (1), PSSCH (2) and PSSCH (3)) which occupy resources continuously in frequency domain in the same time slot. As indicated by reference sign 210, the first device 110 transmits a PRS to the second devices 120 in the same time slot as the one in which the multiple PSSCHs are transmitted, such that the PRS is transmitted over the whole bandwidth occupied by PSSCHs from the first device 110. In this example, the PRS is transmitted via one symbol.

In some embodiments, a PSCCH/PSSCH from the first device 110 may be transmitted towards a respective one of the second devices 120 separately. For example, PSSCH (1) is towards the second device 120-1, PSSCH (2) is towards the second device 120-2, and PSSCH (3) is towards the second device 120-3. In some embodiments, sidelink control information (SCI) is transmitted in two stages. The first-stage SCI is carried on PSCCH and contains information about the resource allocation of the PSSCH. The second-stage SCI is carried on PSSCH.

In these embodiments, the PSCCH/PSSCH from the first device 110 towards a second device (for example, the second device 120-1) in the set of second devices 120 may transmit a source identifier (ID) indicating the first device 110 and a destination ID indicating the second device 120-1. In some embodiments, the PSCCH/PSSCH from the first device 110 towards a second device (for example, the second device 120-1) in the set of second devices 120 may transmit at least one of the following: a time domain resource (for example, which one or more symbols in a time slot) and a frequency resource for the first PRS; a time domain resource (for example, which one or more symbols in a time slot) and a frequency resource for the second PRS from the second device 120-1, a comb size and comb offset for the second PRS from the second device 120-1; or transmission power of the first device 110. The transmission power of the first device 110 facilitates power control at the second device 120-1.

In some alternative embodiments, a PSCCH/PSSCH from the first device 110 may be transmitted towards the set of the second devices 120. For example, PSSCH (1) is towards the set of second devices 120 (i.e., the second devices 120-1, 120-2 and 120-3). PSSCH (2) and PSSCH (3) may transmit other information towards one or more other devices other than the set of second devices 120.

In these embodiments, the PSCCH/PSSCH (e.g., PSSCH (1)) from the first device 110 towards the set of second devices 120 may transmit a source identifier (ID) indicating the first device 110 and a destination ID indicating the set of second devices 120. For example, the destination ID may be a group ID indicating the set of second devices 120. In another example, the destination ID may comprise a set of IDs for the set of second devices 120. In some embodiments, the PSCCH/PSSCH (e.g., PSSCH (1)) from the first device 110 towards the set of second devices 120 may transmit at least one of the following: a time domain resource (for example, which one or more symbols in a time slot) and a frequency resource for the first PRS; time domain resources (for example, which one or more symbols in a time slot) and frequency resources for the second PRSs from the set of second devices 120, a comb size and comb offsets for the second PRSs from the second devices 120; or transmission power of the first device 110. The transmission power of the first device 110 facilitates power control at the second devices 120. In this case, the PSCCH/PSSCH (e.g., PSSCH (1)) from the first device 110 towards the set of second devices 120 may transmit the above information in groupcast.

FIG. 2C illustrates a diagram 200C illustrating another example transmission of a PRS from a target device according to some embodiments of the present disclosure. Comparing with FIG. 2B, the difference in FIG. 2C is that the PRS is transmitted via multiple symbols. In this way, an improved performance of PRS transmission from a target device may be attained. As indicated by reference sign 220 in FIG. 2C, the PRS is transmitted in three symbols. It is to be understood that the present disclosure does not limit the number of symbols conveying the PRS. Other details of FIG. 2C are similar with that of FIG. 2B, and will not be repeated here for concise.

So far, the PRS transmission from a target device according to embodiments of the present disclosure is described. Such PRS transmission may be used in combination with any suitable positioning or ranging solutions, and the present disclosure does not limit this aspect.

Example Implementation of PRS Transmission from Supporting Device

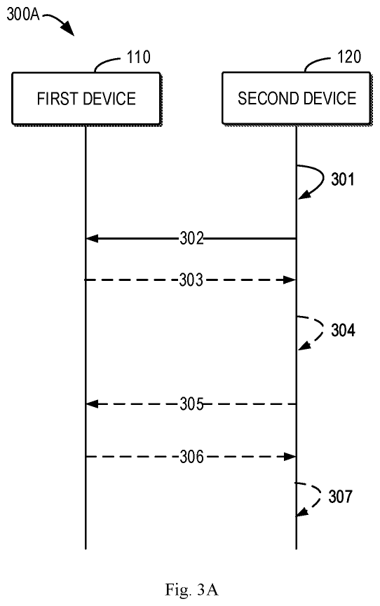

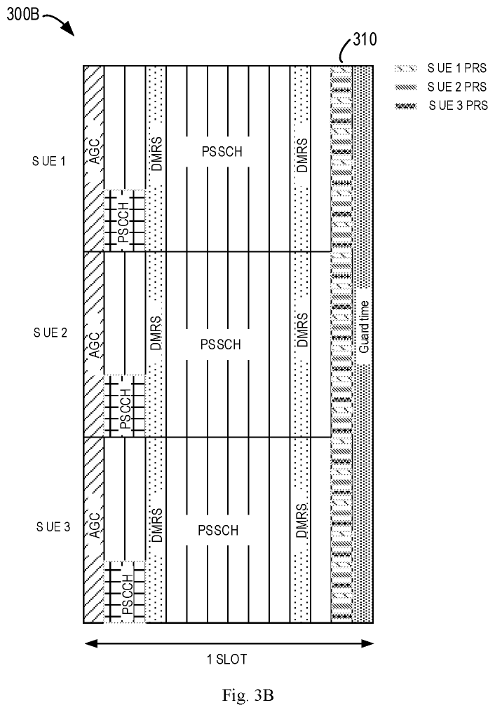

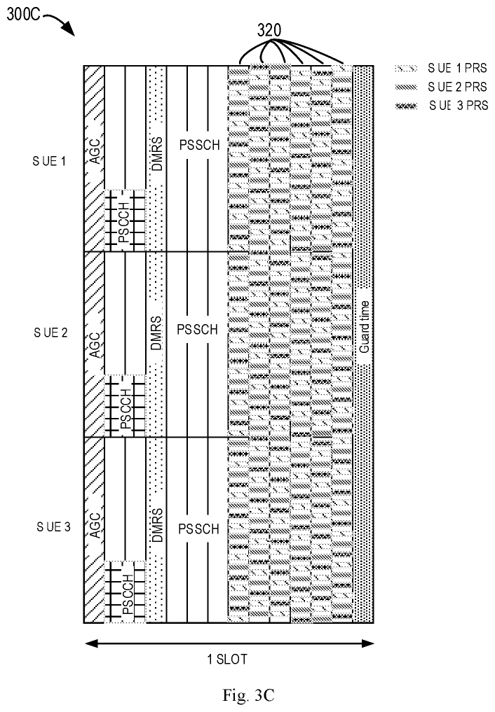

In this embodiment, a solution of PRS transmission from a supporting device is described with reference to FIGS. 3A, 3B and 3C.

FIG. 3A illustrates a flowchart illustrating another process 300A of communication in sidelink positioning according to some embodiments of the present disclosure. For the purpose of discussion, the process 300A will be described with reference to FIG. 1. The process 300A may involve the first and second devices 110 and 120 as illustrated in FIG. 1. It would be appreciated that although the process 300A has been described in the communication environment 100 of FIG. 1, this process may be likewise applied to other communication scenarios. Assuming that the first device 110 is to be positioned by using a set of the second devices 120 (i.e., the second devices 120-1, 120-2 and 120-3). The number of second devices in the set of second devices 120 may be greater than or equal to 2. That is, the first device 110 is a target device, and the set of second devices are a set of supporting devices.

As shown in FIG. 3A, a second device 120 (for example, any of the second devices 120-1, 120-2 and 120-3) generates 301 a PRS (for convenience, also referred to as a second PRS herein). The PRS may be designed in any suitable forms, and the present disclosure does not limit this aspect.

Then the second device 120 transmits 302 the second PRS to the first device 110. According to embodiments of the present disclosure, the second PRS is at least transmitted over a bandwidth occupied by a set of sidelink data channels (for convenience, also referred to as a second set of sidelink data channels herein) associated with the set of second devices 120 in a time slot (for convenience, also referred to as a second time slot herein). The second set of sidelink data channels are transmitted from the set of second devices 120 to the first device 110.

In some embodiments, the second PRS may be transmitted over the whole bandwidth occupied by the second set of sidelink data channels from the set of supporting devices.

In some embodiments, sidelink data channels in the second set of sidelink data channels may be transmitted in the same time slot (i.e., in the second time slot). In some embodiments, the sidelink data channels in the second set of sidelink data channels may be distributed continuously in frequency domain. In this way, transmission performance of PRS from a supporting device may be enhanced and accuracy of sidelink positioning may be improved. Of course, the sidelink data channels in the second set of sidelink data channels may be not distributed continuously in frequency domain. The present disclosure does not limit this aspect.

In some embodiments, the second device 120 may receive 303, from the first device 110, information (i.e., the first information) of a resource to be used for transmission of the second PRS in a time slot (i.e., the second time slot). In some embodiments, the second device 120 may receive the first information with a PRS (also referred to as a first PRS herein) from the first device 110 in another time slot (also referred to as a first time slot herein). For example, the second device 120 may receive a PSCCH/PSSCH conveying the first information and associated PRS in the same time slot (i.e., in the first time slot). In some embodiments, the second time slot may be later in time domain than the first time slot. Of course, the second time slot may be earlier in time domain than the first time slot, or the second time slot and the first time slot may be the same time slot.

In some alternative embodiments, the second device 120 may receive the information indicative of the resource from a third device (not shown) serving the second device 120. For example, the third device may be a network device.

With the received resource information from the first device 110 or the third device, the second device 120 may transmit the second PRS. In some embodiments, the resources for the set of second devices 120 may be coordinated so that second PRSs from the set of second devices 120 are at least transmitted over the whole bandwidth occupied by the second set of sidelink data channels associated with the set of second devices 120 in the same time slot (i.e., in the second time slot). Thereby, by exploiting wider bandwidth for PRS transmissions from a supporting device, transmission latency may be reduced to better realize fast positioning and ranging/positioning performance may be improved.

In some alternative embodiments, with the received resource information from the first device 110 or the third device, the second device 120 may not transmit the second PRS in the resource if it determines the resource is not suitable for transmission.

In some embodiments, the second device 120 may generate 304 information for positioning of the first device 110 (for convenience, also referred to as second information herein) based on the first PRS received from the first device 110. For example, the second device 120 may generate a measurement (e.g., arriving time, AoA, AoD and so on) on the first PRS. Then the second device 120 may transmit 305 the second information to the first device 110. In some embodiments, the second device 120 may transmit the second information with the second PRS in the same time slot (i.e., in the second time slot). For example, the second device 120 may transmit, to the first device 110, a PSCCH/PSSCH conveying the second information and associated PRS in the same time slot (i.e., in the second time slot).

In some embodiments, the second device 120 may receive 306, from the first device, information (for convenience, also referred to as third information herein) indicative of transmission power of the first device 110. The second device 120 may determine 307 transmission power for transmission of the second PRS based on the received transmission power. For example, transmission of the second PRS from a supporting device may be power controlled based on path loss between the target device and the supporting device.

In some embodiments, the second PRS may be transmitted via one symbol. In some embodiments, the second PRS may be transmitted via multiple symbols. In some embodiments, the second PRS may be transmitted in a comb structure with a comb offset over the whole bandwidth occupied by the second set of sidelink data channels.

For illustration, some examples for PRS transmission from a supporting device will be described with reference to FIGS. 3B and 3C. FIG. 3B illustrates a diagram 300B illustrating an example transmission of a set of PRSs from a set of supporting devices according to some embodiments of the present disclosure. For the purpose of discussion, this will be described with reference to FIG. 1. Assuming that the first device 110 is a target device, and the second devices 120 are supporting devices.

In the example of FIG. 3B, the set of second devices 120 (for convenience, denoted as S UE 1, S UE 2 and S UE 3) transmits respective PSSCHs which occupy resources continuously in frequency domain in the same time slot. As indicated by reference sign 310, the set of second devices 120 transmits the set of PRSs to the first device 110 in the same time slot as the one in which the respective PSSCHs are transmitted, such that the set of PRSs are transmitted over the whole bandwidth occupied by PSSCHs from the set of second devices 120. In this example, the set of PRSs is transmitted via one symbol. As shown in FIG. 3B, the set of PRSs from the set of second devices 120 have a comb structure with different comb offsets, as indicated by S UE 1 PRS, S UE 2 PRS and S UE 3 PRS.

In some embodiments, a set of PSCCHs/PSSCHs from the set of second devices 120 may be transmitted towards the same destination, i.e., the first devices 110. In some embodiments, sidelink control information (SCI) is transmitted in two stages. The first-stage SCI is carried on PSCCH and contains information about the resource allocation of the PSSCH. The second-stage SCI is carried on PSSCH.

In these embodiments, a PSCCH/PSSCH from a second device (for example, the second device 120-1) in the set of second devices 120 may transmit a source identifier (ID) indicating the second device 120-1 and a destination ID indicating the first device 110. In some embodiments, the PSCCH/PSSCH from the second device (for example, the second device 120-1) may transmit at least one of the following: the second information (for example, measurement on the first PRS); a location of the second device 120-1; a time domain resource (which one or more symbols in the time slot) and a frequency resource for the second PRS from the second device 120-1; or a comb size and comb offset for the second PRS from the second device 120-1.

FIG. 3C illustrates a diagram 300C illustrating another example transmission of a set of PRSs from a set of supporting devices according to some embodiments of the present disclosure. Comparing with FIG. 3B, the difference in FIG. 3C is that each PRS in the set of PRSs is transmitted via multiple symbols. In this way, an improved performance of PRS transmission from a supporting device may be attained. As indicated by reference sign 320 in FIG. 3C, each PRS in the set of PRSs is transmitted in six symbols. It is to be understood that the present disclosure does not limit the number of symbols conveying the PRS. Other details of FIG. 3C are similar with that of FIG. 3B, and will not be repeated here for concise.

So far, the PRS transmission from a support device according to embodiments of the present disclosure is described. Such PRS transmission may be used separately or in combination with the PRS transmission from a target device described with reference to FIGS. 2A to 2C, and also may be used in combination with any suitable positioning or ranging solutions. The present disclosure does not limit these aspects.

### Example Implementation of Sidelink Positioning

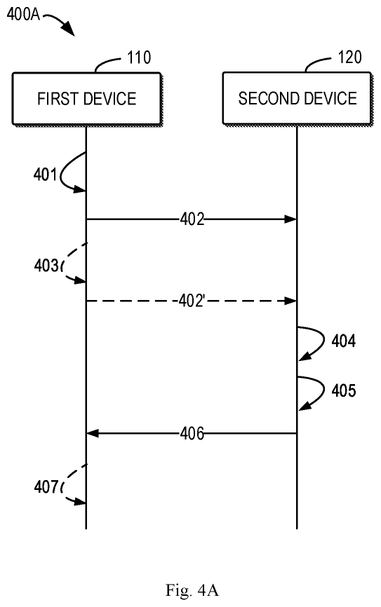

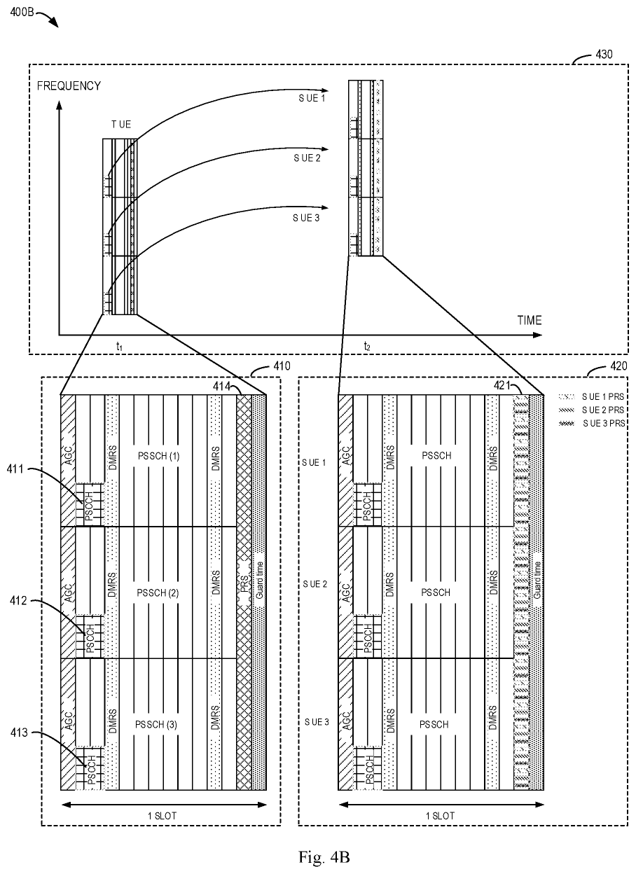

For illustration, the following description will be made on a solution of sidelink positioning based on PRS transmissions between a target device and a set of supporting devices. The embodiment incorporates the PRS transmissions as described with reference to FIGS. 2A to 3C. This will be described with reference to FIGS. 4A and 4B.

FIG. 4A illustrates a flowchart illustrating still another process 400A of communication in sidelink positioning according to some embodiments of the present disclosure. For the purpose of discussion, the process 400A will be described with reference to FIG. 1. The process 400A may involve the first and second devices 110 and 120 as illustrated in FIG. 1. It would be appreciated that although the process 400A has been described in the communication environment 100 of FIG. 1, this process may be likewise applied to other communication scenarios. Assuming that the first device 110 is to be positioned by using a set of the second devices 120 (i.e., the second devices 120-1, 120-2 and 120-3). That is, the first device 110 is a target device, and the set of second devices are a set of supporting devices.

As shown in FIG. 4A, the first device 110 generates 401 a PRS (for convenience, also referred to as a first PRS herein). Then the first device 110 transmits 402 the first PRS to the set of second devices 120. In some embodiments, the first device 110 may generate 403 respective information (for convenience, also referred to as first information herein) of a resource to be used for transmission of another PRS (also referred to as a second PRS herein) from a respective device in the set of second device 120. The first device 110 may transmit 402′ the first information with the first PRS to the set of second device 120.

Return to FIG. 4A, upon reception of the first PRS, each device in the set of second devices 120 generates 404 information (also referred to as second information herein) for positioning of the first device 110 based on measurement on the first PRS. Each device in the set of second devices 120 also generates 405 a PRS (for convenience, also referred to as a second PRS herein), and transmits 406 the second PRS and the second information to the first device 110 based on the resource indicated by the first information.

Upon reception of second PRSs and second information from the set of second devices 120, the first device 110 may determine 407 its location (i.e., positioning) based on measurement on the second PRSs and the second information. For example, the first device 110 may determine a RTT based on measurement on the second PRSs and the second information. Of course, the first device 110 may also perform the positioning based on any other suitable positioning solutions. In some alternative embodiments, the first device 110 may transmit the measurement on the second PRSs and the second information to a third device serving the first device 110. In this case, the positioning of the first device 110 is done by the third device.

FIG. 4B illustrates a diagram 400B illustrating an example positioning for a target device by using a set of support devices according to some embodiments of the present disclosure. As shown in FIG. 4B, reference sign 410 denotes the PRS transmission from the first device 110 to the set of second devices 120, reference sign 420 denotes the PRS transmissions from the set of second devices 120 to the first device 110, and reference sign 430 denotes coordination among the PRS transmissions in time and frequency domains.

As indicated by reference sign 410, the first device 110 may transmit information indicative of a resource used for a second device (denoted as S UE 1) in the set of second devices 120 in PSCCH 411. The first device 110 may transmit information indicative of a resource used for a second device (denoted as S UE 2) in the set of second devices 120 in PSCCH 412. The first device 110 may transmit information indicative of a resource used for a second device (denoted as S UE 3) in the set of second devices 120 in PSCCH 413. As indicated by reference sign 414, the first device 110 transmits a PRS to the set of second devices 120 in the whole bandwidth occupied by PSSCH (1) for S UE 1, PSSCH (2) for S UE 2 and PSSCH (3) for S UE 3 in the same time slot.

As indicated by reference sign 420, the set of second devices 120 (for convenience, denoted as S UE 1, S UE 2 and S UE 3) transmits respective PSSCHs which occupy resources continuously in frequency domain in the same time slot. As indicated by reference sign 421, the set of second devices 120 transmits the set of PRSs to the first device 110 in the same time slot as the one in which the respective PSSCHs are transmitted. The set of PRSs are transmitted over the whole bandwidth occupied by PSSCHs for S UE 1, S UE 2 and S UE 3 in the same time slot. The set of PRSs from the set of second devices 120 have a comb structure with different comb offsets, as indicated by S UE 1 PRS, S UE 2 PRS and S UE 3 PRS.

As indicated by reference sign 430, the first device 110 may transmit the first PRS and the first information to the set of second devices 120 at time instant t₁, as shown by the reference sign 410. The first information indicates the resources to be used for second PRSs from the set of second device 120 at time instant t₂. The set of the second device 120 may transmit the second PRSs and the second information over the respective resources at the time instant t₂, as shown by the reference sign 420.

According to embodiments of the present disclosure, a PSCCH (1st stage SCI) from the first device 110 (i.e., a target device) at the time instant t₁ includes resource allocation of 1st/2nd transmissions. With current specification, resource allocation of 1st/2nd transmissions is used by a target device for transmissions. However, for coordinated PRS transmission according to embodiments of the present disclosure, resource allocation of 1st transmission is used by a target device for transmissions, and resource allocation of 2nd transmissions are used by a set of supporting devices for transmissions. The resource allocation of 2nd transmissions may be used for PSCCH/PSSCH transmitted from a supporting device conveying positioning related information (i.e., the second information), or may be used for PRS transmitted from a supporting device.

In some embodiments, the time instant t₁ and t₂ may be associated with sidelink primary synchronization signal (S-PSS)/sidelink secondary synchronization signal (S-SSS) in NR (or Primary sidelink synchronization signal (PSSS)/Secondary sidelink synchronization signal (SSSS) in LTE) which are transmitted to allow a supporting device to achieve sidelink synchronization when they do not have another source of synchronization available.

It is to be understood that a target device or supporting device involved in described solutions can be installed in a vehicle, a road side unit, or a device of a vulnerable road user, for example. The described solutions of PRS transmission may also apply other use cases, such as public safety and IoT use cases. The types of the target device or supporting device may have different capabilities thus some coordination is expected for example between the target device and supporting device, e.g. in case the target device is a vehicle and the supporting device would be a mix of other devices, such as vehicles and vulnerable road user devices.

Further, it is to be understood that the solution of sidelink positioning as described with reference to FIGS. 4A and 4B is merely an example scenario in which the PRS transmission from a target device as described with reference to FIGS. 2A and 2B and the PRS transmission from a supporting device as described with reference to FIGS. 3A and 3B are applied in combination. The PRS transmission from a target device as described with reference to FIGS. 2A and 2B and the PRS transmission from a supporting device as described with reference to FIGS. 3A and 3B may be applied to any other suitable scenarios in combination or separately.

In addition, it is to be noted that the processes 200A, 300A and 400A as shown in FIGS. 2A, 3A and 4A are merely examples, and may have additional or less operations.

Embodiments of the present disclosure allow efficient and low latency sidelink based ranging/positioning where the needs to transmit PRS and related PSCCH/PSSCH (containing measurement information) are shared between corresponding target and supporting devices. A target device may coordinate the transmissions for supporting devices, thus reducing the likelihood of collisions in case of random or sensing based selection of resources. PRS transmission from a supporting device may be power controlled based on path loss between the target device and the supporting device. This may reduce ICI for PRS reception at the target device to combat near far effect. The resources in which PSSCH is transmitted may be scheduled or configured by a third device (for example, network device) or determined through a sensing procedure conducted autonomously by the target device. Thus, embodiments of the present disclosure allow coordinated transmission, thus avoiding the sensing step and risk of collision. Further, embodiments of the present disclosure allow flexible coexistence between PSCCH/PSSCH with simultaneous PRS and legacy PSCCH/PSSCH (without PRS) in the same time slot.

### Example Implementation of Methods

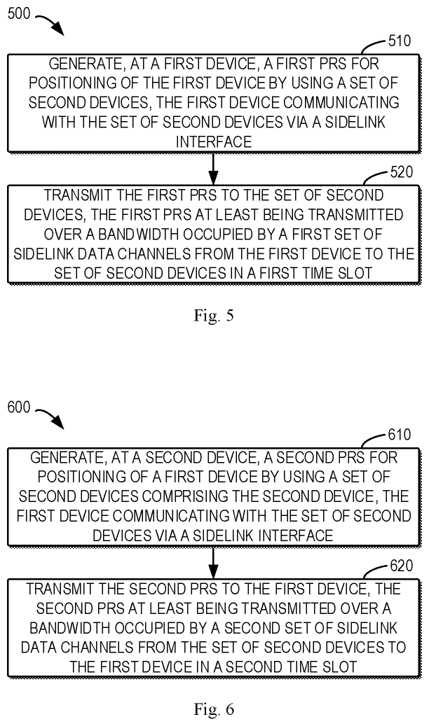

Corresponding to the above processes, example embodiments of the present disclosure also provide methods of communication. FIG. 5 illustrates a flowchart of a method 500 implemented at a first device as a target device according to some embodiments of the present disclosure. For the purpose of discussion, the method 500 will be described with reference to FIG. 1. Assuming that the first device 110 is to be positioned by using a set of the second devices 120 (i.e., the second devices 120-1, 120-2 and 120-3). That is, the first device 110 is a target device, and the set of second devices are a set of supporting devices. The first device 110 communicates with the set of second devices 120 via a sidelink interface.

At block 510, the first device 110 generates a first PRS for positioning of the first device 110 by using the set of second devices 120.

At block 520, the first device 110 transmits the first PRS to the set of second devices 120. The first PRS is at least transmitted over a bandwidth occupied by a first set of sidelink data channels from the first device 110 to the set of second devices 120 in a first time slot. By exploiting wider bandwidth for PRS transmission from a target device, transmission latency may be reduced to better realize fast positioning and ranging/positioning performance may be improved.

In some embodiments, the first PRS may be transmitted via one symbol. In some embodiments, the first PRS may be transmitted via multiple symbols. In this way, performance of PRS transmission may be further improved.

In some embodiments, sidelink data channels in the first set of sidelink data channels may be transmitted in the first time slot. In some embodiments, the sidelink data channels in the first set of sidelink data channels may be distributed continuously in frequency domain. In this way, performance of PRS transmission from a target device may be enhanced and accuracy of sidelink positioning may be improved.

In some embodiments, the first device 110 may generate first information indicative of a resource to be used for transmission of a second PRS from a second device in the set of second devices 120 to the first device 110 in a second time slot, and transmit the first information to the second device. In some embodiments, the first device 110 may transmit, to the second device, the first information with the first PRS in the first time slot. In some embodiments, the second time slot may be later in time domain than the first time slot. In this way, a target device may coordinate the transmissions for supporting devices, thus reducing the likelihood of collisions in case of random or sensing based selection of resources.

In some embodiments, the first device 110 may receive, from the set of second devices 120, a set of second PRSs in a second time slot. A second PRS in the set of second PRSs is at least transmitted over a bandwidth occupied by a second set of sidelink data channels from the set of second devices 120 to the first device 110 in the second time slot.

In some embodiments, the first device 110 may also receive, from the set of second devices 120, a set of second information for the positioning of the first device 110. In some embodiments, the first device 110 may receive the set of second information with the set of second positioning reference signals in the second time slot. In this way, efficient and low latency sidelink based ranging/positioning may be achieved.

In some embodiments, the second PRS in the set of second PRSs may be transmitted via multiple symbols. In some embodiments, the second PRS in the set of second PRSs may be transmitted via one symbol. In some embodiments, the set of second PRSs may comprise a comb structure with different comb offsets. In some embodiments, the first device 110 may position the first device based on the set of second information and the set of second positioning reference signals.

In some embodiments, the first device 110 may transmit, to a second device in the set of second devices 120, third information indicative of transmission power applied by the first device 110. This facilitates determination of pass loss at a supporting device.

With the method 500, an improved transmission of PRS from a target device is achieved, and efficient and low latency sidelink based ranging/positioning is allowed.

FIG. 6 illustrates a flowchart of a method 600 implemented at a second device as a supporting device according to some embodiments of the present disclosure. For the purpose of discussion, the method 600 will be described with reference to FIG. 1. Assuming that the first device 110 is to be positioned by using a set of the second devices 120 (i.e., the second devices 120-1, 120-2 and 120-3). That is, the first device 110 is a target device, and the set of second devices are a set of supporting devices. The first device 110 communicates with the set of second devices 120 via a sidelink interface.

At block 610, a second device in the set of second devices 120 generates a second PRS for positioning of the first device 110 by using the set of second devices 120.

At block 620, the second device transmits the second PRS to the first device 110. The second PRS is at least transmitted over a bandwidth occupied by a second set of sidelink data channels from the set of second devices 120 to the first device 110 in a second time slot. By exploiting wider bandwidth for PRS transmission from a supporting device, transmission latency may be reduced to better realize fast positioning and ranging/positioning performance may be improved.

In some embodiments, the second PRS may be transmitted via one symbol. In some embodiments, the second PRS may be transmitted via multiple symbols. In this way, performance of PRS transmission may be further improved. In some embodiments, the second PRS may have a comb structure with a comb offset over the whole bandwidth occupied by the second set of sidelink data channels.

In some embodiments, sidelink data channels in the second set of sidelink data channels may be transmitted in the second time slot. In some embodiments, the sidelink data channels in the second set of sidelink data channels may be distributed continuously in frequency domain. In this way, performance of PRS transmission from a supporting device may be enhanced and accuracy of sidelink positioning may be improved.

In some embodiments, the second device may receive, from the first device 110, a first PRS in a first time slot, the first PRS at least being transmitted over a bandwidth occupied by a first set of sidelink data channels from the first device 110 to the set of second devices 120 in the first time slot. In some embodiments, the first PRS may be transmitted via one symbol. In some embodiments, the first PRS may be transmitted via multiple symbols.

In some embodiments, the second device may generate, based on the first PRS, second information for the positioning of the first device 110, and transmit the second information to the first device 110. In some embodiments, the second device may transmit, to the first device 110, the second information with the second PRS in the second time slot. In some embodiments, the second time slot may be later in time domain than the first time slot.

In some embodiments, the second device may receive, from the first device 110, first information indicative of a resource to be used for the transmission of the second PRS. In some embodiments, the second device may receive, from the first device 110, the first information with the first PRS in the first time slot. In this way, coordinated transmission of PRS from supporting devices may be done, and the sensing step and risk of collision may be avoided.

In some embodiments, the second device may receive, from the first device 110, third information indicative of transmission power applied by the first device 110, and determine, based on the third information, transmission power for the transmission of the second PRS. In this way, PRS transmission from a supporting device may be power controlled based on path loss between the target device and the supporting device.

With the method 600, an improved transmission of PRS from a supporting device is achieved, and efficient and low latency sidelink based ranging/positioning is allowed.

It is to be noted that the operations of the methods 500 and 600 correspond to that of the processes 200A, 300A and 400A described above, and thus other details are not repeated here for concise.

### Example Implementation of Apparatus and Devices

Example embodiments of the present disclosure also provide the corresponding apparatus. In some embodiments, an apparatus (for example, the first device 110) capable of performing the method 500 may comprise means for performing the respective steps of the method 500. The means may be implemented in any suitable form. For example, the means may be implemented in a circuitry or software module.

In some embodiments, the apparatus comprises: means for generating, at a first device, a first positioning reference signal for positioning of the first device by using a set of second devices, wherein the first device communicates with the set of second devices via a sidelink interface; and means for transmitting the first positioning reference signal to the set of second devices, the first positioning reference signal at least being transmitted over a bandwidth occupied by a first set of sidelink data channels from the first device to the set of second devices in a first time slot. In some embodiments, the first positioning reference signal may be transmitted via multiple symbols.

In some embodiments, sidelink data channels in the first set of sidelink data channels are transmitted in the first time slot. In some embodiments, the sidelink data channels in the first set of sidelink data channels are distributed continuously in frequency domain.

In some embodiments, the apparatus may further comprise: means for generating first information indicative of a resource to be used for transmission of a second positioning reference signal from a second device in the set of second devices to the first device in a second time slot; and means for transmitting the first information to the second device.

In some embodiments, the means for transmitting the first information may comprise means for transmitting, to the second device, the first information with the first positioning reference signal in the first time slot.

In some embodiments, the apparatus may further comprise: means for receiving, from the set of second devices, a set of second positioning reference signals in a second time slot, a second positioning reference signal in the set of second positioning reference signals at least being transmitted over a bandwidth occupied by a second set of sidelink data channels from the set of second devices to the first device in the second time slot; and means for receiving, from the set of second devices, a set of second information for the positioning of the first device. In some embodiments, the means for receiving the set of second information may comprise means for receiving the set of second information with the set of second positioning reference signals in the second time slot. In some embodiments, the second positioning reference signal in the set of second positioning reference signals is transmitted via multiple symbols. In some embodiments, the set of second positioning reference signals may comprise a comb structure with different comb offsets. In some embodiments, the second time slot may be later in time domain than the first time slot.

In some embodiments, the apparatus may further comprise means for positioning the first device based on the set of second information and the set of second positioning reference signals. In some embodiments, the apparatus may further comprise means for transmitting, to a second device in the set of second devices, third information indicative of transmission power applied by the first device.

In some embodiments, an apparatus (for example, the second device 120) capable of performing the method 600 may comprise means for performing the respective steps of the method 600. The means may be implemented in any suitable form. For example, the means may be implemented in a circuitry or software module.

In some embodiments, the apparatus comprises: means for generating, at a second device, a second positioning reference signal for positioning of a first device by using a set of second devices comprising the second device, wherein the first device communicates with the set of second devices via a sidelink interface; and means for transmitting the second positioning reference signal to the first device, the second positioning reference signal at least being transmitted over a bandwidth occupied by a second set of sidelink data channels from the set of second devices to the first device in a second time slot. In some embodiments, the second positioning reference signal may be transmitted via multiple symbols.

In some embodiments, sidelink data channels in the second set of sidelink data channels are transmitted in the second time slot. In some embodiments, the sidelink data channels in the second set of sidelink data channels are distributed continuously in frequency domain.

In some embodiments, the apparatus may further comprise: means for receiving, from the first device, a first positioning reference signal in a first time slot, the first positioning reference signal at least being transmitted over a bandwidth occupied by a first set of sidelink data channels from the first device to the set of second devices in the first time slot; means for generating, based on the first positioning reference signal, second information for the positioning of the first device; and means for transmitting the second information to the first device. In some embodiments, the first positioning reference signal is transmitted via multiple symbols.

In some embodiments, the apparatus may further comprise means for receiving, from the first device, first information indicative of a resource to be used for the transmission of the second positioning reference signal. In some embodiments, the means for receiving the first information comprises means for receiving, from the first device, the first information with the first positioning reference signal in the first time slot. In some embodiments, the second time slot is later in time domain than the first time slot.

In some embodiments, the means for transmitting the second information comprises means for transmitting, to the first device, the second information with the second positioning reference signal in the second time slot.

In some embodiments, the apparatus may further comprise: means for receiving, from the first device, third information indicative of transmission power applied by the first device; and means for determining, based on the third information, transmission power for the transmission of the second positioning reference signal.

In some embodiments, the means comprises at least one processor; and at least one memory including computer program code, the at least one memory and computer program code configured to, with the at least one processor, cause the performance of the apparatus.

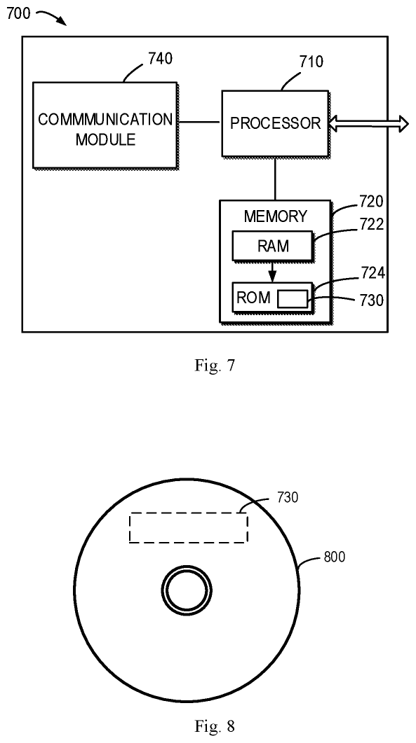

FIG. 7 is a simplified block diagram of a device 700 that is suitable for implementing embodiments of the present disclosure. The device 700 may be provided to implement the communication device, for example the first device 110, or the second devices 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 720. The processor 710 may perform any suitable actions and processing by loading the program 730 into the RAM 720.

The embodiments of the present disclosure may be implemented by means of the program 730 so that the device 700 may perform any process of the disclosure as discussed with reference to FIGS. 1 to 6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIGS. 5 and 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-51. (canceled)

52. A first device comprising:
at least one processor; and
at least one memory including computer program code,
the at least one memory and the computer program code configured to, with the at least one processor, cause the first device to:
generate a first positioning reference signal for positioning of the first device by using a set of second devices, wherein the first device communicates with the set of second devices via a sidelink interface; and
transmit the first positioning reference signal to the set of second devices, the first positioning reference signal at least being transmitted over a bandwidth occupied by a first set of sidelink data channels from the first device to the set of second devices in a first time slot.

53. The first device of claim 52, wherein sidelink data channels in the first set of sidelink data channels are transmitted in the first time slot.

54. The first device of claim 53, wherein the sidelink data channels in the first set of sidelink data channels are distributed continuously in frequency domain.

55. The first device of claim 52, wherein the first device is further caused to:
generate first information indicative of a resource to be used for transmission of a second positioning reference signal from a second device in the set of second devices to the first device in a second time slot; and
transmit the first information to the second device.

56. The first device of claim 55, wherein the first device is caused to transmit the first information by:
transmitting, to the second device, the first information with the first positioning reference signal in the first time slot.

57. The first device of claim 52, wherein the first device is further caused to:
receive, from the set of second devices, a set of second positioning reference signals in a second time slot, a second positioning reference signal in the set of second positioning reference signals at least being transmitted over a bandwidth occupied by a second set of sidelink data channels from the set of second devices to the first device in the second time slot; and
receive, from the set of second devices, a set of second information for the positioning of the first device.

58. The first device of claim 57, wherein at least one of:
the first device is caused to receive the set of second information by receiving the set of second information with the set of second positioning reference signals in the second time slot;
the second positioning reference signal in the set of second positioning reference signals is transmitted via multiple symbols;
the set of second positioning reference signals comprise a comb structure with different comb offsets; or
the first device is further caused to position the first device based on the set of second information and the set of second positioning reference signals.

59. The first device of claim 55, wherein the second time slot is later in time domain than the first time slot.

60. The first device of claim 52, wherein the first positioning reference signal is transmitted via multiple symbols.

61. The first device of claim 52, wherein the first device is further caused to:
transmit, to a second device of the set of second devices, third information indicative of transmission power applied by the first device.

62. A second device comprising:
at least one processor; and
at least one memory including computer program code,
the at least one memory and the computer program code configured to, with the at least one processor, cause the second device to:
generate a second positioning reference signal for positioning of a first device by using a set of second devices comprising the second device, wherein the first device communicates with the set of second devices via a sidelink interface; and
transmit the second positioning reference signal to the first device, the second positioning reference signal at least being transmitted over a bandwidth occupied by a second set of sidelink data channels from the set of second devices to the first device in a second time slot.

63. The second device of claim 62, wherein sidelink data channels in the second set of sidelink data channels are transmitted in the second time slot.

64. The second device of claim 63, wherein the sidelink data channels of the second set of sidelink data channels are distributed continuously in frequency domain.

65. The second device of claim 62, wherein the second device is further caused to:
receive, from the first device, a first positioning reference signal in a first time slot, the first positioning reference signal at least being transmitted over a bandwidth occupied by a first set of sidelink data channels from the first device to the set of second devices in the first time slot;
generate, based on the first positioning reference signal, second information for the positioning of the first device; and
transmit the second information to the first device.

66. The second device of claim 65, wherein at least one of:
the second device is further caused to receive, from the first device, first information indicative of a resource to be used for the transmission of the second positioning reference signal;
the second device is caused to transmit the second information by transmitting, to the first device, the second information with the second positioning reference signal in the second time slot;
the first positioning reference signal is transmitted via multiple symbols; or
the second time slot is later in time domain than the first time slot.

67. The second device of claim 66, wherein the second device is caused to receive the first information by:
receiving, from the first device, the first information with the first positioning reference signal in the first time slot.

68. The second device of claim 65, wherein the second device is further caused to:
receive, from the first device, third information indicative of transmission power applied by the first device; and
determine, based on the third information, transmission power for the transmission of the second positioning reference signal to the first device.

69. The second device of claim 62, wherein the second positioning reference signal is transmitted via multiple symbols.

70. An apparatus of communication, comprising:
means for generating, at a first device, a first positioning reference signal for positioning of the first device by using a set of second devices, wherein the first device communicates with the set of second devices via a sidelink interface; and
means for transmitting the first positioning reference signal to the set of second devices, the first positioning reference signal at least being transmitted over a bandwidth occupied by a first set of sidelink data channels from the first device to the set of second devices in a first time slot.
